(19) United States
(12) Patent Application Publication
(10) Pub. No.: US 2010/0031545 A1
(43) Pub. Date: Feb. 11, 2010

(54) Advertising support with illuminated magnifier

(76) Inventor: William H. Waterhouse, Norman, OK (US)

Correspondence Address: Phillips Murrah, P.C., 101 N. Robinson Ave., Corporate Tower, 13th Floor, OKLAHOMA CITY, OK, 73102, US

(21) Appl. No.: 12/587,836

(22) Filed: Oct. 14, 2009

Related U.S. Application Data
(63) Continuation-in-part of application No. 10/982,964, filed on Nov. 5, 2004, now Pat. No. 7,621,060.

(51) Int. Cl. G09F 15/00

(52) U.S. Cl. 40/606.03

(57) ABSTRACT

A table-top advertising support with illuminated magnifier includes a taller section containing a magnifier or fresnel lens and a lamp-switch-battery assembly in a lower portion and an upper portion having vertically aligned elongated slots formed by cooperation of staggered opposing tabs. The taller section is attached to a shorter section containing a second fresnel lens disposed within a frame.

### CROSS-REFERENCE TO RELATED APPLICATIONS

This application is a continuation-in-part of U.S. patent application Ser. No. 10/982,964, filed on Nov. 5, 2004, now pending and incorporated by reference herein.

### BACKGROUND OF THE INVENTION

1. Field of the Invention

In general, the present invention relates to a restaurant table top advertising device known as a table topper. More particularly, the present invention relates to a new and improved portable table-top advertising support, which includes an illuminated magnifier for use by customers in need of light and or magnification for reading.

2. Description of the Prior Art

Restaurants commonly use table-top advertising supports to provide information to diners. The information may relate to business hours, new dishes, or beverage promotions. Restaurants are often dimly lit, so diners may have difficulty reading either the menu or, more frequently, the sales slip (also referred to herein as the check) presented for payment following completion of a meal.

As often found, restaurants frequently use low or subtle lighting for creating a desired atmosphere in the dinning room. This makes the reading of menus and bills sometimes difficult for those with good vision and impossible for those with visual problems.

The restaurant and bar industry is constantly looking for an easily moved, durable, and cost effective means to provide customers with a visual aid for both lighting and magnifying such things as menus and bills. Thus, there is a need for a new and improved construction of same. The current invention provides a superior product where the prior art fails.

### SUMMARY OF THE INVENTION

In view of the foregoing disadvantages inherent in the known types of visual aids and table top advertising now present in the prior art, the present invention provides a convenient, easily transported, and durable construction. As such, the general purpose of the present invention, which will be described subsequently in greater detail, is to provide a new and improved table top advertising and visual aid device which has all the advantages of the prior art and none of the disadvantages.

It is contemplated that the invention may include a table-top advertising support with illuminated magnifier, which may include a taller section containing a fresnel lens and a lamp-switch-battery assembly in a lower portion and an upper portion having vertically aligned elongated slots formed by cooperation of staggered opposing tabs. The taller section may be attached to a shorter section containing a second fresnel lens disposed within a frame. As used herein, the term “advertising” or “information” includes, without limitation, advertisements/pricing for food and beverages, emergency numbers, sayings, news of coming events/specials, or any other visual material.

It is also understood that the current invention is not limited to restaurants and bars. The current invention may be utilized in banks, stores and other locations where it is desirable to provide an advertising, notice placement, or other point of purchase that may also include a light and or magnifier.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved table top advertising apparatus with a means for providing light and magnification for reading where the prior art fails.

It is a further object of the present invention to provide a new and improved table top advertising apparatus with a means for providing light and magnification which is of a durable and reliable construction and may be easily and efficiently manufactured and marketed.

An even further object of the present invention is to provide a new and improved table top advertising apparatus with a means for providing light and magnification which is susceptible to a low cost of construction with regard to both materials and labor, and which accordingly is then susceptible to low prices of sale to the consuming public, thereby making such invention economically available to those in the field and public in general.

Still another object of the present invention is to provide a new and improved table top advertising apparatus with a means for providing light and magnification which provides all of the advantages of the prior art, while simultaneously overcoming some of the disadvantages normally associated therewith.

While still another object of the present invention is to provide a new and improved table top advertising apparatus with a means for providing light and magnification which allows for a an easily changeable advertising and posting available for placement on table tops of restaurants and bars.

These, together with other objects of the invention, along with the various features of novelty which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there are illustrated preferred embodiments of the invention.

### BRIEF DESCRIPTION OF THE DRAWINGS, ILLUSTRATIONS, AND PICTURES

The invention will be better understood and objects other than those set forth above will become apparent when consideration is given to the following detailed description thereof. Such description makes reference to the annexed pictorial illustrations, graphs, drawings, exhibits and appendices wherein:

FIG. 1 shows the advertising support with illuminated magnifier of the present invention wherein the two mating sections are assembled.

FIG. 2 is another view of the lower portion of the table topper shown in FIG. 1, wherein the two mating sections are exploded away from each other.

FIG. 3 is a view of the shorter of the two mating sections shown in FIG. 2.

FIG. 4 is a view of the taller of the two mating sections shown in FIG. 2.

FIG. 5 is another view of the table topper shown in FIG. 1.

FIG. 6 shows another advertising support with illuminated magnifier according to the present invention.

FIG. 7 is another view of the table topper shown in FIG. 6.

FIG. 8 is a bottom view of the table topper shown in FIG. 6.

FIG. 9 is a stylized schematic of the battery-switch-lamp of the present invention.

FIG. 10 is an enlarged cross-section, with a portion of the vertical advertising panel cut away, showing an alternate structure for the bottom portions of the two mating sections of the present invention.

FIG. 11 is an enlarged cross-section, with a portion of the vertical advertising panel cut away, showing still another alternate structure for the bottom portions of the two mating sections of the present invention.

FIG. 12 is an enlarged cross-section, with a portion of the vertical advertising panel cut away, showing still another alternate structure for the bottom portions of the two mating sections of the present invention.

FIG. 13 is an enlarged cross-section, with a portion of the vertical advertising panel cut away, showing the structure of the device shown in FIG. 12 combined with a switch for activating the battery-powered lamp.

FIG. 14 is an enlarged cross-section, with a portion of the vertical advertising panel cut away, showing another configuration of a switch deployed between the two mating sections.

FIG. 15 is an enlarged cross-section, with a portion of the vertical advertising panel cut away, showing still another configuration of a switch deployed between the two mating sections.

FIG. 16 is an enlarged cross-section, with a portion of the vertical advertising panel cut away, showing still another configuration of a switch deployed between the two mating sections.

FIG. 17 is an enlarged cross-section, with a portion of the vertical advertising panel cut away, showing still another configuration of a switch deployed between the two mating sections.

FIG. 18 shows another advertising support with illuminated magnifier according to the present invention.

FIG. 19 is another view of the table topper shown in FIG. 18, wherein the structural elements are exploded vertically for ease of viewing.

FIG. 20 is a partially exploded perspective view of a preferred embodiment of the invention.

FIG. 21 is a perspective view of another preferred embodiment of the invention.

### DETAILED DESCRIPTION OF THE PREFERRED EMBODIMENTS

It is contemplated to generally provide a housing wherein selective advertising or information may be placed in a removable or non-removable manner and wherein a magnifier and or light may be utilized. The light may be automatically or selectively activated such as but not limited to activation when the housing is moved or lifted.

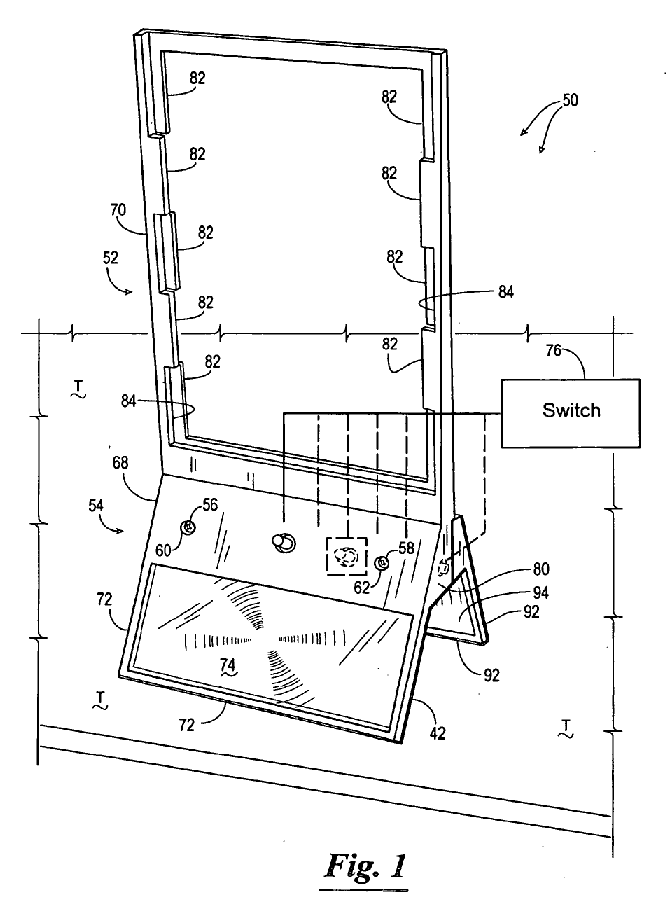

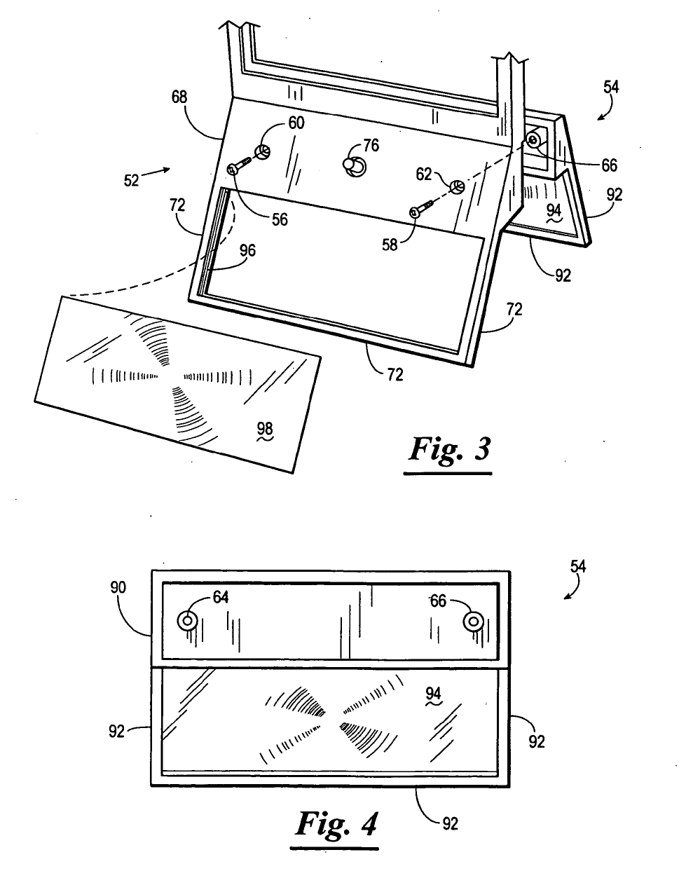

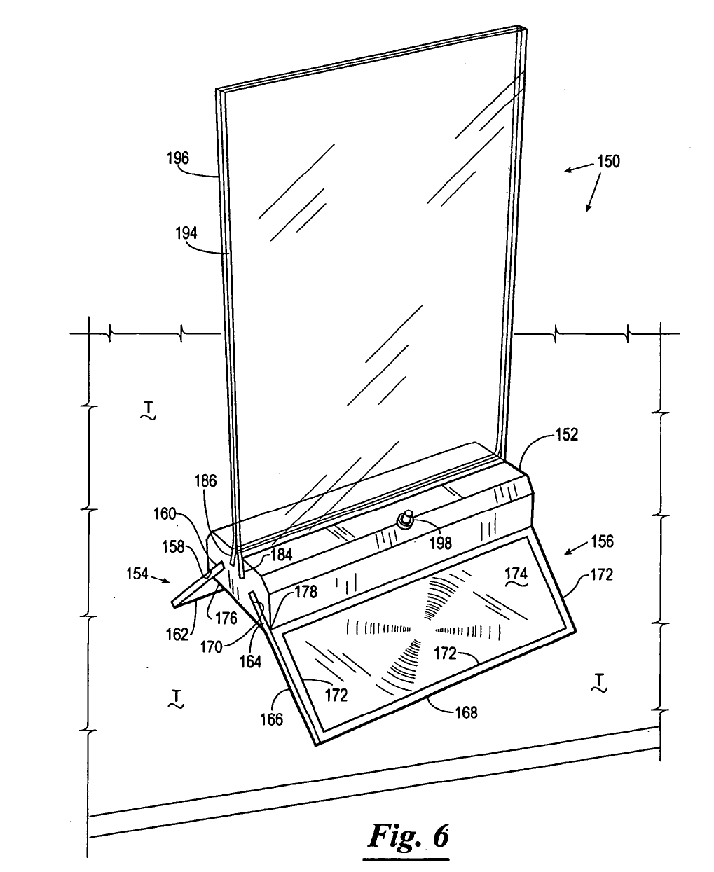

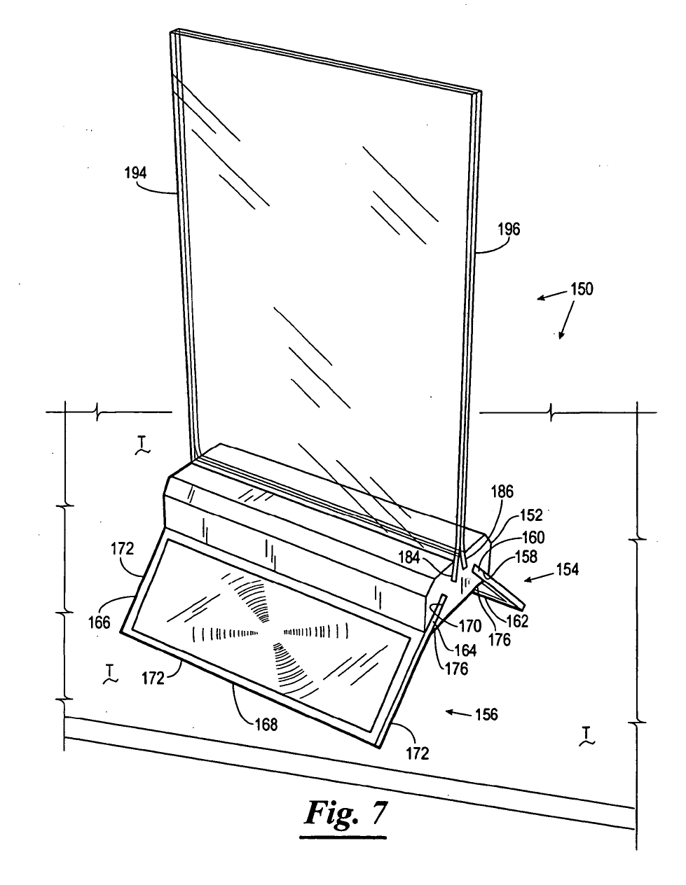

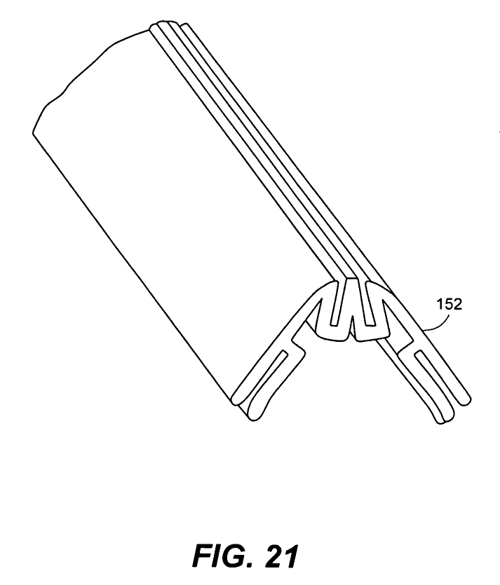

Referring now to the drawings, wherein like reference numerals designate corresponding structure throughout the views, and referring in particular to FIGS. 1-21, and more specifically referring to FIGS. 1-5, a table topper 50 includes a taller section 52 and a shorter section 54. As shown more clearly in FIGS. 3-4, screws 56, 58 disposed in bores 60, 62 in the taller section 52 engage receiving bores 64, 66 in the shorter section 54.

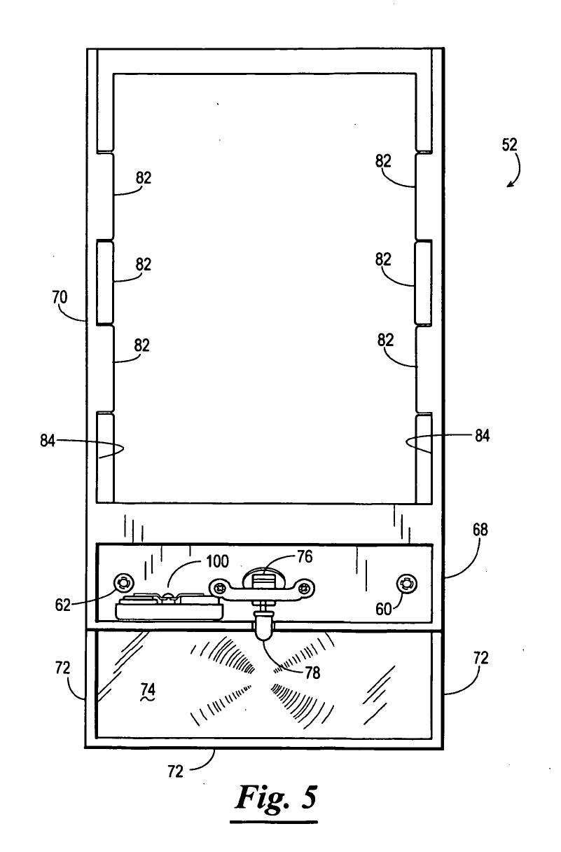

Referring now to FIG. 1, the taller section 52 includes a lower portion 68 and an upper portion 70. A frame 72 in the lower portion 68 houses an integrally molded fresnel lens 74. A switch 76 located above the frame 72 in the lower portion 68 actuates a lamp 78 (see FIG. 5). The lower portion 68 of the taller section 52 includes an end panel 80. As illustrated by the phantom lines and the phantom switches in FIG. 1, the switch 76 can be located at any convenient location.

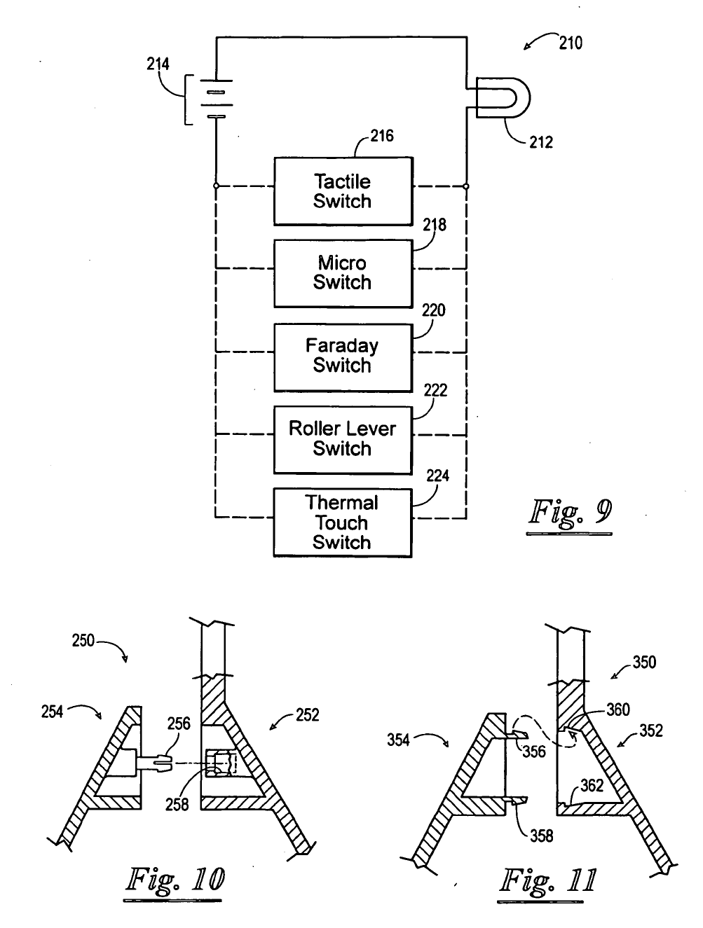

The switch shown in FIG. 1 is a common momentary micro switch. It will be understood by one skilled in the art that various types of switches can be utilized according to applicant's invention. Tactile switches, micro switches, Faraday switches, roller lever switches, and thermal touch switches (referred to herein, collectively, as touch switches) are known in the art and suitable for use in applicant's table topper 50 (see FIG. 9).

It will be further understood by one skilled in the art that, while the lamp 78 in FIG. 5 is a light emitting diode (LED), any convenient lamp can be used including, without limitation, incandescent bulbs and halogen lamps.

Referring now to FIGS. 1, 2, and 5, staggered opposing tabs 82 in the upper portion 70 of the taller section 52 cooperate to form a pair of vertically aligned elongated slots 84. The vertically aligned elongated slots 84 are adapted to receive advertising or other informational material to be displayed in the table topper 50.

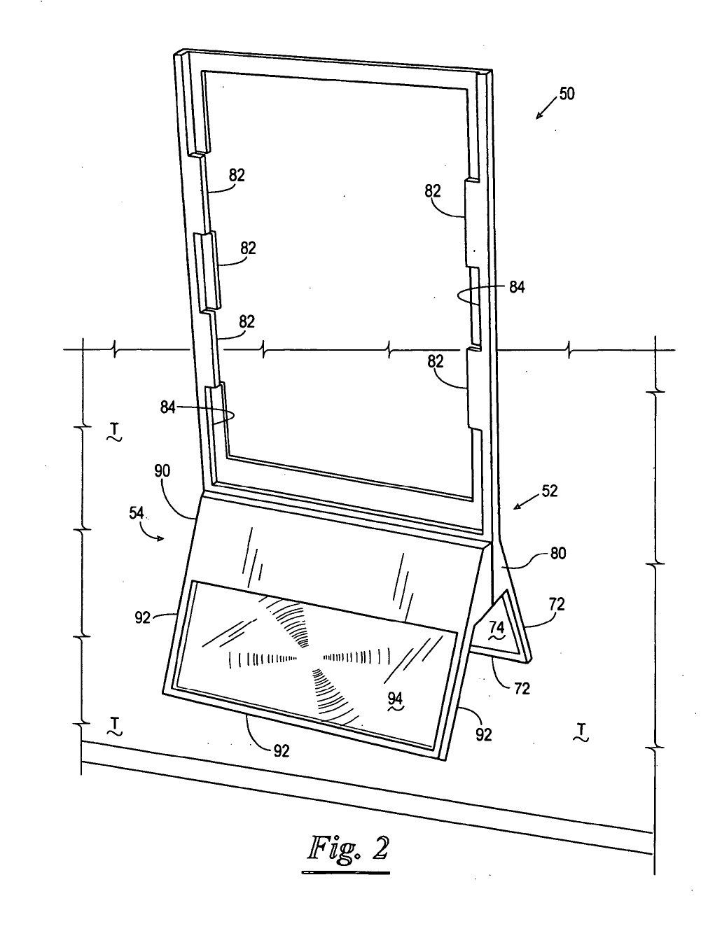

Referring now to FIGS. 1-2, the shorter section 54 includes an upper portion 90 and a frame 92 surrounding an integrally molded fresnel lens 94.

Referring now to FIG. 3, a ledge 96 in the frame 72 in the lower portion 68 of the taller section 52 receives a removable fresnel lens 98.

It will be understood by one skilled in the art that the fresnel lens 94 can be molded simultaneously with the frame 92 and the upper portion 90 of the shorter section 54. In the alternative, the upper portion 90 and the frame 92 can be molded in a single operation, followed by insertion of the removable fresnel lens 98 in the frame 92. Simultaneous molding of the fresnel lens together with the frame 92 and the upper portion 90 results in a significant cost reduction.

It will be further understood by one skilled in the art that the fresnel lens 74 can be molded in a single operation with the remainder of the taller section 52 or, in the alternative, a fresnel lens can be attached to the frame 72 in a second operation.

Referring now to FIG. 5, the switch 76 is viewed from the back side of the taller section 52. The lamp 78 is powered by a battery 100 when the lamp circuit is switched on.

Referring now to FIGS. 6-8, another table topper 150 according to applicant's invention includes a junction block 152 supported by leg member 154 and magnifying leg member 156. An upper portion 158 of the leg member 154 is press fit into a slot 160 in the junction block 152, and a lower edge 162 of the leg member 154 rests on the table top T. The magnifying leg member 156 has an upper portion 164, a lower portion 166, and a lower edge 168. The upper portion 164 of the magnifying leg member 156 is press fit into a slot 170 in the junction block 152. The lower portion 166 of the magnifying leg member 156 includes a frame portion 172. A molded fresnel lens 174 is attached to the frame portion 172 of the magnifying leg member 156.

Still referring to FIGS. 6-8, the slots 160, 170 are cut at an angle in outside bottom edge portions 176, 178, respectively of the junction block 152 so that the lower edges 162, 168 of the leg member 154 and the magnifying leg member 156, respectively, flare outwardly down and away from the junction block 152 to provide a stable base of support for the table topper 150.

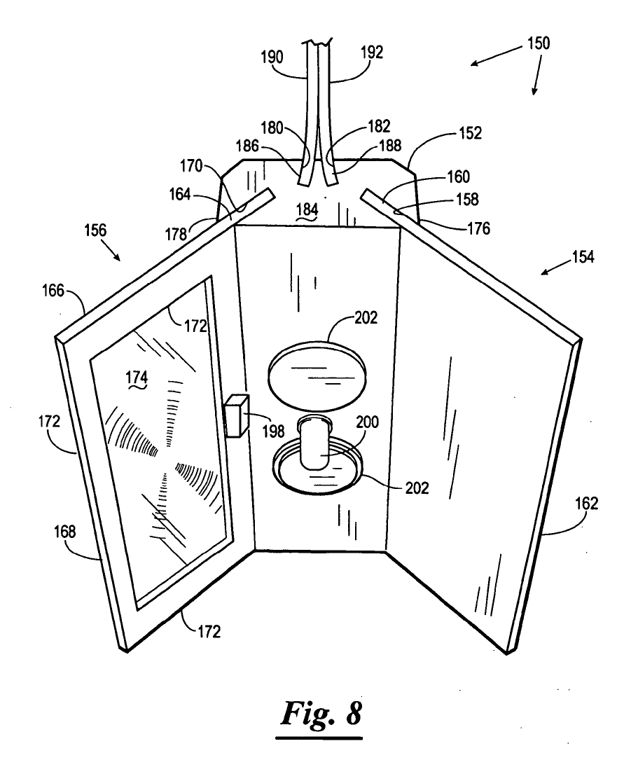

As best seen in FIG. 8, slots 180, 182 in the top center portion 184 of the junction block 152 receive bottom portions 186, 188 respectively of vertical panes 190, 192. The bottom portions 186, 188 are frictionally biased within the slots 180, 182, respectively. The slots 180, 182 are angled upwardly toward each other so that, when inserted into the slots 180, 182, upper portions 194, 196 of the vertical panes 190, 192 are pressed together so that a card or paper containing information (not shown) inserted between the vertical panes 190, 192 is held firmly in place.

Referring now to FIGS. 6 and 8, a switch 198 activates a lamp 200 powered by a batteries 202.

It will be understood by one skilled in the art that, while the junction block 152 shown in FIGS. 6-8 is depicted as a more-or-less rectangular cube, the junction block 152 can be spherical or any other particular shape permitting attachment of the leg member 154, the magnifying leg member 156, the vertical panes 194, 196, the switch 198, the lamp 200, and the batteries 202.

Referring now to FIG. 9, a circuit diagram 210 shows a lamp 212 powered by a battery 214 actuated by, in the alternative, a tactile switch 216, a micro switch 218, a Faraday switch 220, a roller lever switch 222, or a thermal touch switch 224. Each switch set forth herein is known in the art and, therefore, will not be discussed in detail. Any type of switch can be used in applicant's Advertising Support with Illuminated Magnifier.

Referring now to FIG. 10, another table topper 250 according to the present invention includes a taller section 252 and a shorter section 254. A split barbed projection 256 molded as part of the shorter section 254 mates with a shouldered receptacle 258 molded as part of the taller section 252 to secure the shorter section 254 to the taller section 252.

Referring now to FIG. 11, another table topper 350 according to the present invention includes a taller section 352 and a shorter section 354. Flat barbed projections 356, 358 molded as part of the shorter section 354 mate with detents 360, 362, respectively, molded as part of the taller section 352, to secure the shorter section 354 to the taller section 352.

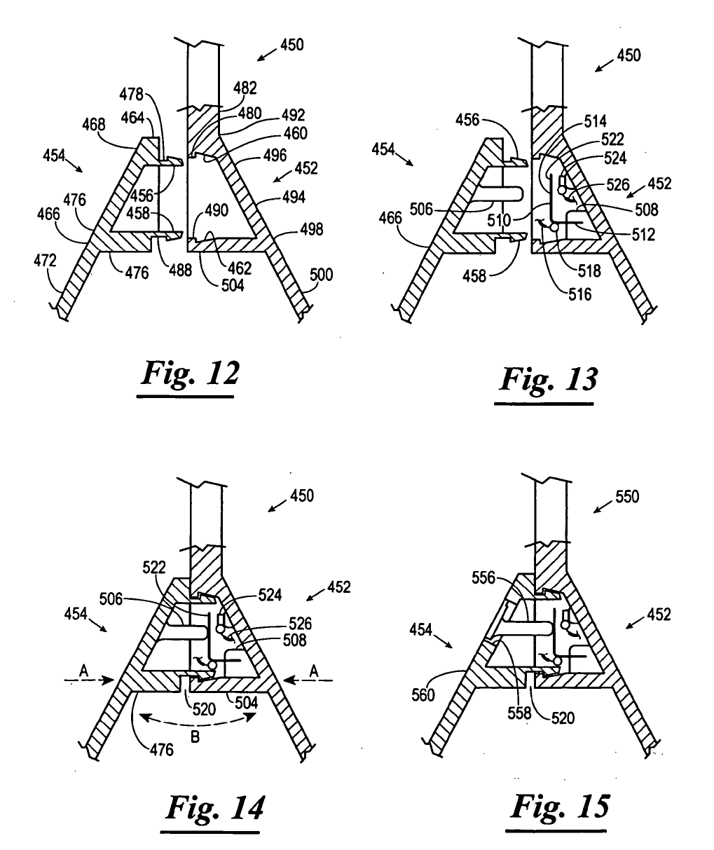

Referring now to FIGS. 12-13, another table topper 450 according to the present invention includes a taller section 452 and a shorter section 454.

Referring now to FIG. 12, a flat barbed projection 456 molded as a part of the shorter section 454 mates with a detent 460 molded as a part of the taller section 452. An extended flat barbed projection 458 molded as a part of the shorter section 454 mates with a detent 462 molded as a part of the taller section 452. The shorter section 454 includes a top ridge 464, a leg member 466 having an upper portion 468, an intermediate portion 470, and a lower portion 472, and a lower edge 474 (not shown; see 166 and 168 in FIGS. 6-8). A horizontal member 476 located adjacent the intermediate portion 470 of the shorter section leg member 466 terminates in the extended flat barbed projection 458. The flat barbed projection 456 projects horizontally from the shorter section leg member 466 adjacent the upper portion 468 of the shorter section leg member 466 just below the top ridge 464.

Still referring to FIG. 12, the flat barbed projection 456 includes a recess 478. The mating detent 460 includes a shoulder 480. When the shorter section 454 and the taller section 452 are assembled, the recess 478 snugly receives the shoulder 480 of the mating detent 460.

Still referring to FIG. 12, the extended flat barbed projection 458 includes an elongated recess 488. The mating detent 462 has a shoulder 490. When the shorter section 454 and the taller section are assembled, the elongated recess 488 loosely receives the shoulder 490 of the mating detent 462.

Still referring to FIG. 12, the taller section 452 includes a junction region 492, a leg member 494 having an upper portion 496, an intermediate portion 498, and a lower portion 500, and a lower edge 502 (not shown). A horizontal member 504 located adjacent the intermediate portion 498 of the taller section leg member 494 terminates in the detent 462 to receive the extended flat barbed projection 458. The detent 460 is located adjacent the upper portion 496 of the taller section leg member 494 to receive the flat barbed projection 456. The junction region 492 refers to the junction of the taller section leg member 494 with an upper portion 482 of the taller section 452.

Referring now to FIGS. 13-14, a switch actuator 506 projects horizontally from the shorter section leg member 466 between the flat barbed projection 456 and the extended flat barbed projection 458 in the shorter section 454. An anchor block 508 molded into the taller section 452 supports an L-shaped conductive spring 510 having a short side 512 and a long side 514. An electrical lead 516 terminates at a terminal 518 in contact with the short side 512 of the L-shaped conductive spring 510. The long side 514 of the L-shaped conductive spring 510 is aligned with the switch actuator 506 when the taller section 452 is secured to the shorter section 454 as shown in FIG. 14 so that a gap 520 is created between portions of the mating extended flat barbed projection 458 and the mating detent 460. The free end 522 of the long side 514 of the L-shaped conductive spring 510 is aligned with a second terminal contact 524 attached to a second electrical lead 526.

Referring now to FIG. 14, as force is applied along A, the shorter section leg member 466 and the taller section leg member 494 move toward each other along B. The switch actuator 506 then contacts the second terminal contact 524 to close the electrical circuit and energize the lamp 200 (see FIGS. 6-8). As the force applied along A is removed, the L-shaped conductive spring 510 causes the shorter section leg member 466 and the taller section leg member 494 to move away from each other along B (and thereby opening the switched circuit).

Referring now to FIG. 15, another table topper 550 according to applicant's invention includes a taller section 452 and a shorter section 454. A removable switch actuator 556 is cemented in place within a cavity 558 in the leg member 560 of the shorter section 454. Otherwise, the table topper 550 show in FIG. 15 operates like the table topper 450 shown in FIGS. 12-14.

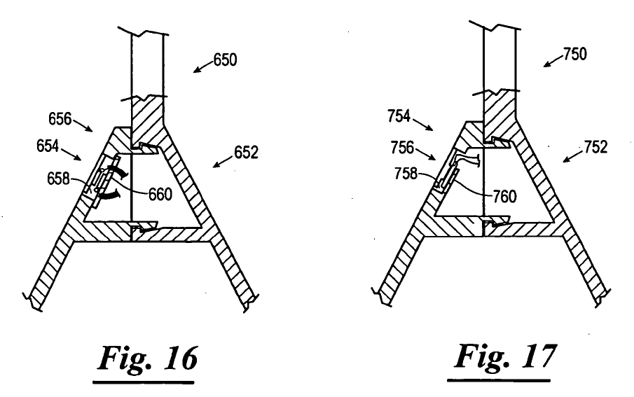

Referring now to FIG. 16, another table topper 650 according to applicant's invention includes a taller section 652 and a shorter section 654. A touch switch 656 is deployed in a cavity 658 in the shorter section 654 and held in place by a backing plate 660.

Referring now to FIG. 17, another table topper 750 according to applicant's invention includes a taller section 752 and a shorter section 754. A touch switch 756 is deployed in a cavity 758 in the shorter section 754 and held in place by a tab 760 integrally molded as part of the shorter section 754.

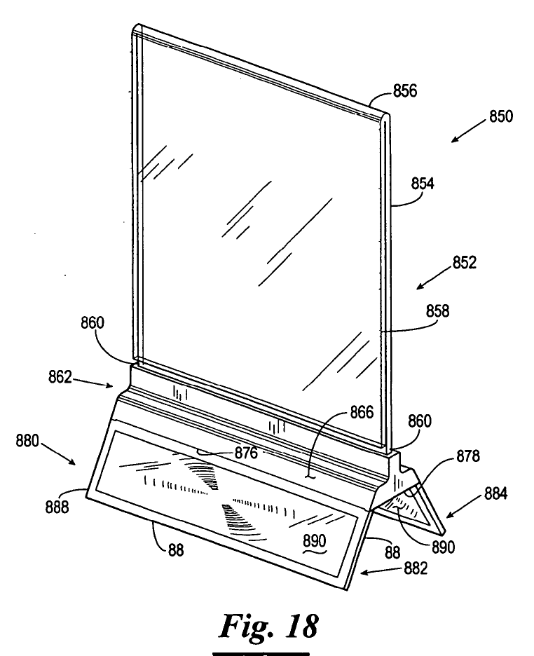

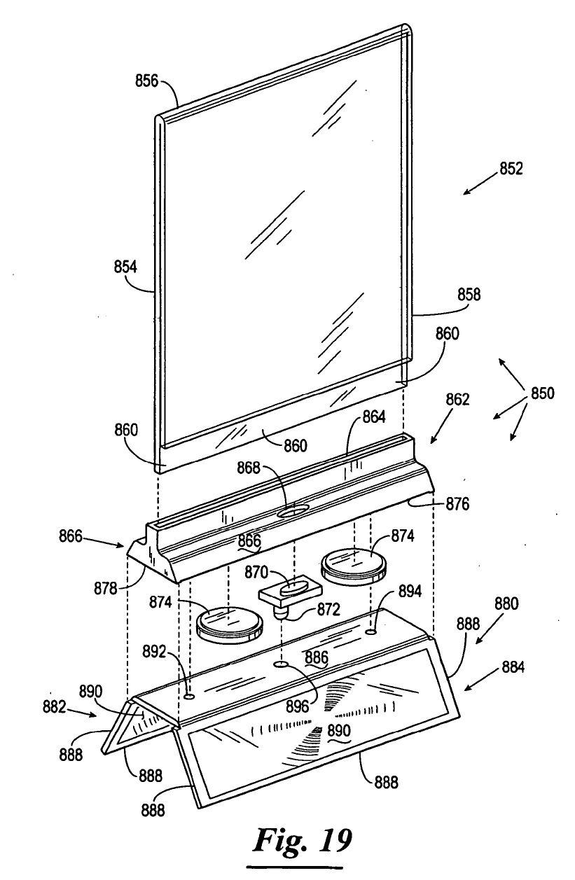

Referring now to FIGS. 18-19, another table topper 850 according to applicant's invention includes a vertical foldover transparent display panel 852 having a longer section 854, a u-shaped fold 856, and a shorter section 858. The longer section 854 has a lower portion 860.

Still referring to FIGS. 18-19, a junction member 862 includes an integrally molded vertical slot 864 upstanding from a downwardly flared portion 866. The vertically upstanding slot 864 receives the lower portion 860 of the longer section 854 of the vertical foldover display panel 852. An aperture 868 in the downwardly flared portion 866 receives a switch 870 connected in series with a lamp 872 and batteries 874. The downwardly flared portion 866 terminates in parallel sided edges 876 and parallel end edges 878.

Still referring to FIGS. 18-19, a base 880 has two leg members 882, 884 connected by a horizontal rectangular section 886. Each leg member 882, 884 includes a frame 888 and a molded fresnel lens 890. The horizontal rectangular section 886 has apertures 892, 894 for routing electrical connectors and a lamp aperture 896. When the table topper 850 is assembled as shown in FIG. 18, the lamp 872 protrudes through the lamp aperture 896 to light the check or sales slip placed in the area between the leg members 882, 884 for viewing through at least one of the fresnel lenses 890.

Still referring to FIGS. 18-19, the horizontal rectangular section 886 terminates in parallel sided edges 898 and parallel end edges 900. As shown more clearly in FIG. 19, the parallel side edges 898 of the horizontal rectangular section 886 engage the parallel side edges 876 of the flared portion 866 of the junction member 862. Likewise, the parallel end edges 900 of the horizontal rectangular section 886 engage the parallel end edges 878 of the flared portion 866 of the junction member 862.

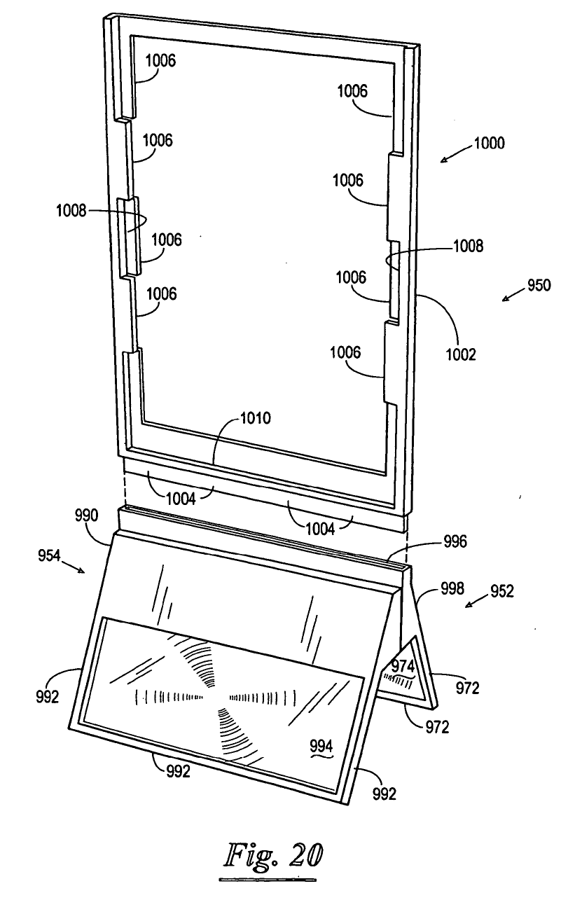

Referring now to FIG. 20, another table topper 950 according to applicant's invention is shown. A first leg member 952 mates with a second leg member 954 (see FIGS. 1-15 for mating details) to form a base. The first leg member 952 includes a frame 972 and a fresnel lens 974 within the frame 972. The second leg member 954 includes a frame 992 and another fresnel lens 994 within the frame 992.

Still referring to FIG. 20, the first leg member 952 includes an integrally molded vertical slot 996 upstanding from a top portion 998 of the first leg member 952. A vertical display member 1000 includes an upper frame portion 1002 for holding advertising or informational material (not shown) and a tongue 1004. When assembled for use, the tongue 1004 is inserted in the vertical slot 996 and secured by frictional bias between the tongue 1004 and the structure forming the vertical slot 996. Staggered opposing tabs 1006 in the upper frame portion 1002 of the vertical display member 1000 cooperate to form a pair of vertically aligned elongated slots 1008. The vertically aligned elongated slots 1008 are adapted to receive advertising or other informational material to be displayed in the table topper 950. A bottom rail 1010, essentially co-planar with the vertically aligned elongated slots 1008, supports the advertising or other material.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Changes may be made in the combinations, operations, and arrangements of the various parts and elements described herein without departing from the spirit and scope of the invention.

I claim:

1. A table-top advertising device comprising:
a housing for displaying selected advertising material;
a magnifying lens attached to said housing; and
a light attached to said housing.

2. The device of claim 1 wherein said selective advertising is removable.

3. The device of claim 2 wherein said light is selectively activated.

4. The device of claim 2 wherein said light is automatically activated by movement of said housing.

5. The device of claim 1 wherein said magnifying lens is removable from said housing.

6. The device of claim 5 wherein said light is removable from said housing.
